(19) United States
(12) Patent Application Publication
(10) Pub. No.: US 2016/0093226 A1
(43) Pub. Date: Mar. 31, 2016

(54) IDENTIFICATION AND ALTERING OF USER ROUTINES

(71) Applicant: Microsoft Corporation, Redmond, WA (US)

(72) Inventors: Amit Machluf, Herzeliya (IL); Hen Fitoussi, Tel Aviv (IL); Benny Schlesinger, Ramat-HaSharon (IS)

(21) Appl. No.: 14/500,765

(22) Filed: Sep. 29, 2014

(51) Int. Cl. G09B 5/00

(52) U.S. Cl. CPC G09B 5/00

(57) ABSTRACT

A computerized method includes identifying a first routine of a first user and determining an alteration for the first routine. The alteration can be determined based at least in part on a second routine, where the second routine corresponds to a second user. In addition, or instead, the determining may be based at least in part on generating and selecting one or more alterations and/or selecting one or more enumerated alterations for the first routine. The first routine can be simulated with the alteration to predict a first performance score with respect to multiple future iterations of at least the altered first routine. The alteration may be selected for the first routine based on the prediction of the first performance score and a second performance score with respect to at least the unaltered first routine. The selected alteration for the first routine may be presented to the first user.

### BACKGROUND

It has been said that human beings are creatures of habit. Accordingly, many devices are designed to be adaptable or customizable to accommodate habitual behavior, or routines, of users. For example, many cellular telephones and home telephones permit a user to program speed dial numbers into them, allowing the user to dial the speed dial numbers by pressing only one key or button, rather than having to dial the entire telephone number. Likewise, many computer programs allow the user to customize graphical user interfaces (GUIs) in order to make tools or features that are commonly used more readily accessible. A user that is aware of his/her routines may choose to take advantage of these features to improve the efficiency of their routines.

When a person is aware of certain behavior, the person may choose to alter the behavior in some way to improve their life. However, people have varying levels of skill, knowledge, and/or time that limits their ability to effectively assess their routines. In view of the wide selection of options presented in many aspects of everyday life, a person could live more happily with some external assistance in regulating, monitoring, and advising decisions related to behavior in his/her own life.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Aspects of the present disclosure relate to the identification and altering of routines of one or more users. A user routine, or a routine of a user, can correspond to a recurring behavior, or behavior pattern, of a user. In further respects, the present disclosure relates to altering routines of one or more users and analyzing the altered routines. The altering may impose one or more constraints of a user or group of users on the altering. The analysis can be used to characterize altered routines, which may reflect one or more performance preferences that can vary from user to user, between groups of users, and/or from routine to routine. Amongst other possibilities, the analysis may be used to determine which altered routines are substantial enough to present to a user, when to present the altered routines to the user, and/or how to present the altered routines to the user. In additional respects, the present disclosure relates to altering and analyzing routines of users with respect to a group of users. These and other concepts are contemplated as being within the scope of the present disclosure.

### BRIEF DESCRIPTION OF THE DRAWINGS

The present invention is described in detail below with reference to the attached drawing figures, wherein:

FIG. 1 is a block diagram showing a system for routines of users in accordance with implementations of the present disclosure;

FIG. 2 is a block diagram showing an exemplary routine management environment in accordance with implementations of the present disclosure;

FIG. 3 is a flow diagram showing a method for analyzing routines of users in accordance with implementations of the present disclosure;

FIG. 4 is a flow diagram showing a method for analyzing routines of users in accordance with implementations of the present disclosure; and

FIG. 5 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the present disclosure relate to the identification and altering of routines of one or more users. A user routine, or a routine of a user, can correspond to a recurring behavior, or behavior pattern, of a user. In certain respects, the present disclosure provides for identifying routines of a user based on aggregated user data. Aggregated user data can comprise a collection of data that corresponds to a user. The user data may be collected by a large variety of possible data sources and/or data systems that on aggregate creates a detailed record of user routines over time. These routines of the user can be identified and extracted from the aggregated user data at a level of scope, accuracy, and quantity that otherwise would not be achievable by the user alone.

It is intended that the aggregation of user data embody robust privacy and data protection for individuals, businesses and public-sector organizations. In this respect, user's may are given control over many aspects related to user data including the ability to opt in or opt out of data collection and/or any of the various tracking or analysis features described herein. Furthermore, safeguards are intended to be implemented protect sensitive user data from access by other parties, including other users, without express consent of the user. Additionally, any user data is intended to by made anonymous when possible.

In further respects, the present disclosure relates to altering routines of one or more users and analyzing the altered routines. One or more alterations may be selected for the routines and the routines may be analyzed with the alterations. For example, one or more routines may be simulated with alterations to predict one or more performance indicators of the routine or routines with the alterations. Performance scores generated by simulation can correspond to multiple future iterations of altered routines, such that the performance scores can quantify the relative performance of the altered routines over time. Thus, performance scores can be used to determine whether or not any of various aspects that characterize performance of the routine would be improved, degraded, or maintained by alterations. These characterizations can also be used to determine which altered routines are substantial enough to present to a user, when to present the altered routines to the user, and/or how to present the altered routines to the user.

In additional respects, the present disclosure relates to altering and analyzing routines of users with respect to a group of users. For example, an alteration of one or more routines of one user in a group may be selected based on one or more routines of another user in the group. Alterations may include combining at least a portion of routines between users, and offloading at least a portion of a routine of one user to one or more other users. Furthermore, alterations may be made to avoid conflicts between routines of users of the group. Multiple routines of each user can be considered and performance indicators can be simulated at the user and/or group level. In some cases, alterations to one or more routines of one user may degrade a performance indicator for a user in the group, but may still be presented and/or suggested to any of the members of the group based on an overall improvement to performance indicators amongst the users of the group.

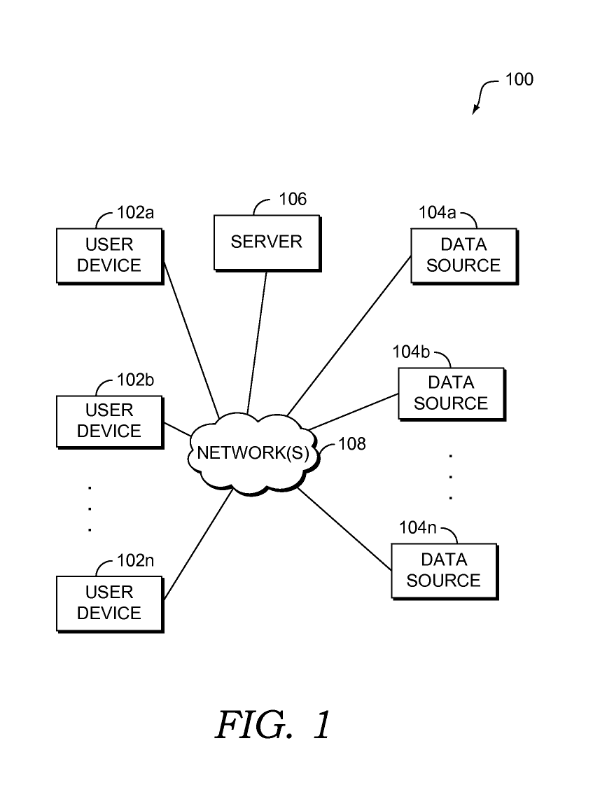

Turning to FIG. 1, a diagram is provided illustrating an exemplary system 100 in which some implementations of the present disclosure may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

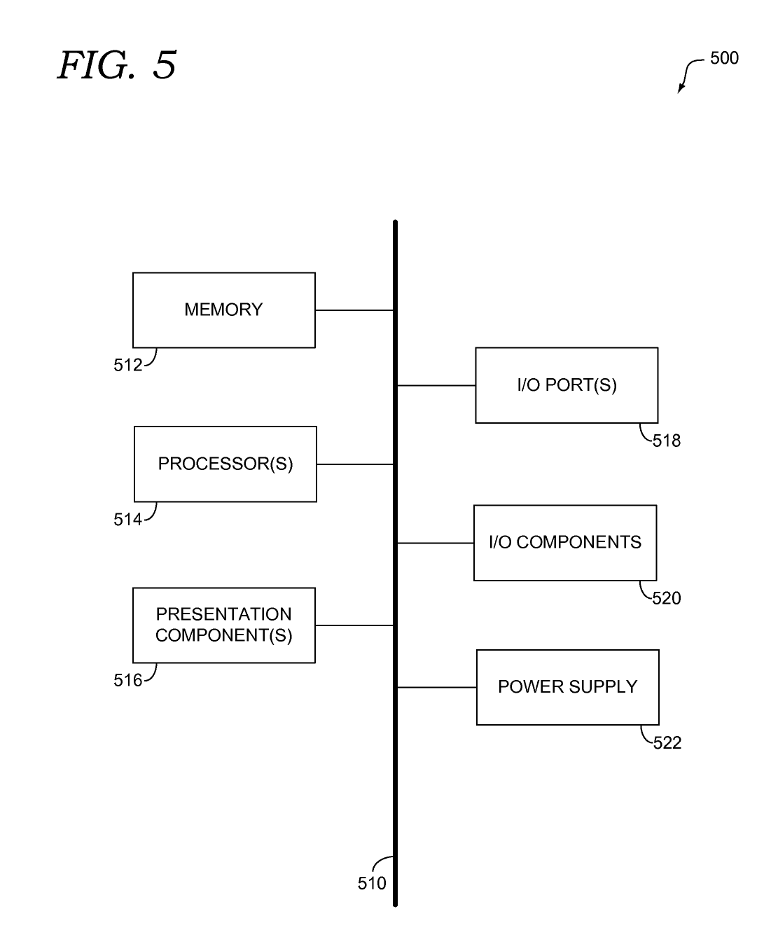

Among other components not shown, system 100 includes a number of user devices, such user devices 102a and 102b through 102n, a number of data sources, such as data sources 104a and 140b through 104n, server 106, and network 108. It should be understood that system 100 shown in FIG. 1 is an example of one suitable computing system architecture. Each of the components shown in FIG. 1 may be implemented via any type of computing device, such as computing device 500, later described with reference to FIG. 5, for example. The components may communicate with each other via network 108, which may include, without limitation, one or more local area networks (LANs) and/or wide area networks (WANs). In exemplary implementations, network 108 comprises the Internet and/or a cellular network, amongst any of a variety of possible public and/or private networks.

It should be understood that any number of user devices, servers, and data sources may be employed within system 100 within the scope of the present disclosure. Each may comprise a single device or multiple devices cooperating in a distributed environment. For instance, server 106 may be provided via multiple devices arranged in a distributed environment that collectively provide the functionality described herein. Additionally, other components not shown may also be included within the distributed environment.

User devices 102a and 102b through 102n can be client devices on the client-side of system 100, while server 106 can be on the server-side of system 100. Server 106 can comprise server-side software designed to work in conjunction with client-side software on user devices 102a and 102b through 102n so as to implement any combination of the features and functionalities discussed in the present disclosure. This division of system 100 is provided to illustrate one example of a suitable system, and there is no requirement for each implementation that any combination of server 106 and user devices 102a and 102b through 102n remain as separate entities.

User devices 102a and 102b through 102n might take on a variety of forms, such as a personal computer (PC), a laptop computer, a mobile phone, a smartphone, a smartwatch, a tablet computer, a wearable computer, a personal digital assistant (PDA), an MP3 player, a global positioning system (GPS) device, a video player, a handheld communications device, a workstation, any combination of these delineated devices, or any other suitable device.

Also in FIG. 1, data sources 104a and 140b through 104n can comprise data sources and/or data systems, which are configured to make data available to any of the various constituents of system 100. In some cases, at least one of the data sources is discrete from user devices 102a and 102b through 102n and server 106. However, at least one of the data sources may be incorporated into at least one of those components.

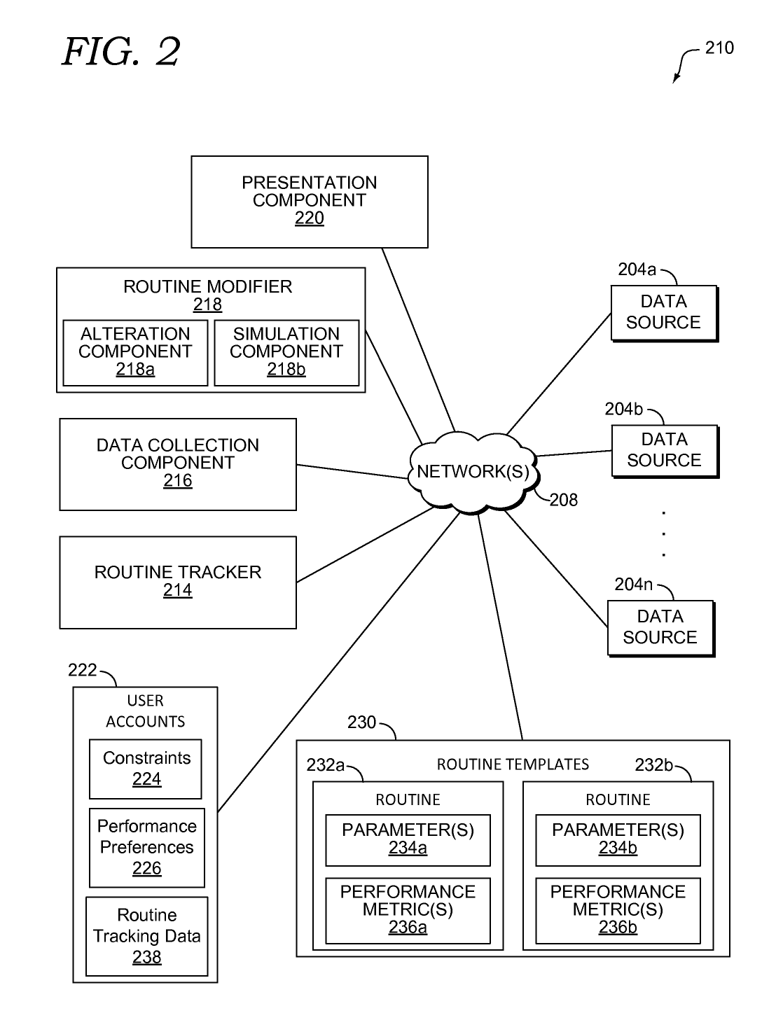

System 100 can be utilized to implement a routine management environment in which routines may be identified, tracked, altered, analyzed, and/or presented with respect to one or more users and/or groups of users. Referring now to FIG. 2 with FIG. 1, FIG. 2 illustrates exemplary routine management environment 210 of system 100, in accordance with implementations of the present disclosure.

Routine management environment 210 includes routine tracker 214, which is configured to identify and track routines of one or more users based on user data and/or interpretive data from one or more data sources, such as any combination of data sources 204a and 204b through 204n, corresponding to data sources 104a and 104b through 104n in FIG. 1.

Data collection component 216 can be employed to facilitate the aggregation of user data of one or more users and/or interpretive data for routine tracker 214. In some instances data collection component 216 may aggregate user data as needed by routine tracker 214. In other cases, at least some of the user data may be aggregated, stored, and optionally reformatted by data collection component 216. By identifying and tracking routines of users aggregated user data, routine tracker 214 can achieve at a level of scope, accuracy, and quantity that otherwise would not be achievable by the user alone.

User data of a user can comprise data that is associated with or otherwise corresponds to the user. Users can each correspond to one of user accounts 222. In particular, as used herein, a user can correspond to a user account, which optionally may be associated with one or more of a username, a password, a user device (e.g. a media access control address), an Internet Protocol address, a universally unique identifier (UUID), and/or other user identifiers.

Any combination of data sources 104a and 104b through 104n can comprise user data of one or more users that may be aggregated by data collection component 216. The data may be associated with a user account, such as one of user accounts 222. In some cases, the data may not be directly associated with the user account, but may be associated with another user account that is known or designated to correspond to the same user. For example, one of user accounts 222 may be linked to one or more user accounts, which may be in another system or other systems. As examples, the same user could have a Facebook account, a PayPal account, a Google Account, a Twitter account, a bank account, an eBay account, and an Amazon account, which each may be associated with user data of the user.

User data can be aggregated from a variety of sources where the data may be in a variety of formats. Examples of user data includes smartphone data, home sensors data, global positioning system (GPS) data, vehicle signal data, wearable device data, user device data, gyroscope data, accelerometer data, calendar data, email data, credit card usage data, purchase history data, and many more.

Interpretive data can correspond to data utilized by routine tracker 214 to interpret user data. For example, interpretive data can be used to provide context to user data, which can support determinations or inferences made by routine tracker 214. As an example, user data could indicate that a user ate an apple, whereas interpretative data can comprise nutritional information utilized by routine tracker 214 to infer that the user ate a healthy meal or snack.

Routine tracker 214 can be implemented in a variety of different ways so as to identify and/or track routines. In some cases, routine tracker 214 comprises an inference engine (e.g. a rule-based inference engine) that is utilized to identify and/or track routines.

In some respects, routine tracker 214 may optionally identify and track routines based on routine templates 230. Routine templates 230 comprises routines, such as routines 232a and 232b. Each routine includes one or more behavior parameters and optionally one or more performance indicators, which are later described in further detail. For example, routine 232a includes behavior parameters 234a and performance indictors 236a and routine 232b includes behavior parameters 234b and performance indictors 236b.

One or more behavior parameters that are assigned to a routine each define an aspect of user behavior and can collectively define the routine. A behavior parameter may correspond to an action or other behavior of a user. Different routines may share one or more behavior parameters, but may be distinguished by at least one behavior parameter. At least some behavior parameters of a routine may have sequencing requirements, and may optionally depend on one or more other behavior parameters so as to form steps of the routine. Some behavior parameters optionally may comprise one or more behavior variables, which can be filed in with user data by routine tracker 214, as provided by data collection component 216. These behavior parameters may also be referred to as variable behavior parameters. Behavior variables generated from user data of a user may be stored in association with that user, for example, in a corresponding one of user accounts 222. Other behavior parameters may be static and can be referred to as static behavior parameters. By utilizing, behavior parameters and behavior variables to define a routine, the same routine can encompass a large number of variations in the routine in routine templates 230.

Routine tracker 214 may search and/or analyze user data for any of a variety of behavior parameters and/or behavior variables thereof. By matching user data to one or more behavior parameters and/or behavior variables thereof, routine tracker 214 may identify and/or track a routine that corresponds to the one or more behavior parameters with respect to a user. Furthermore, routine tracker 214 can determine whether or not a user practices a routine based on whether or not one or more behavior parameters of the routine are satisfied.

To illustrate the forgoing, a routine may comprise a user driving to a store. One behavior parameter may correspond to a departure location. The behavior parameter may comprise a behavior variable, such as a departure location name. Routine tracker 214 may infer the departure from a location as being satisfied based on user data comprising GPS data on the user's phone (e.g. user device 102a of FIG. 1), and may identify and store the departure location name based on interpretive data that includes map data used to associate coordinates from the user's phone with a corresponding location name. Thus, for one user, the departure location name may be “home,” and for another user the departure location may be “work,” as examples.

In the aforementioned example, where a static behavior parameter is utilized, the behavior parameter corresponding to the departure location could be “home.” In this case, routine tracker 214 may determine that a user did not satisfy the behavior parameter because the user instead departed from work or was not near the user's home in the GPS data being analyzed. Thus, in this case, routine tracker 214 may determine that the user did not practice an instance of a routine by failing to satisfy the behavior parameter. Other possible behavior parameters in the present example include arrival or departure time, arrival or departure location coordinates, arrival location name, driving path, driving speed, gas mileage, vehicle name, and many more. Any number of these and other behavior parameters that may define the routine can be static (i.e. preset) with respect to user data of a user or variable.

In determining whether or not a user practices a routine, routine tracker 214 can determine a confidence score of the routine, and/or respective confidence scores of behavior parameters. Where a confidence score of a routine exceeds a threshold value, the user may be determined as having practiced the routine. Similarly, where a confidence score of a behavior parameter exceeds a threshold value, the user may be determined as practicing the behavior that corresponds to the behavior parameter. Where all confidence scores of all behavior parameters assigned to a routine exceed threshold values, the user may be determined as practicing the routine. It should be noted that any combination of the aforementioned threshold values may be the same or different with respect to one another.

Confidence scores of behavior parameters and/or routines can be determined utilizing one or more confidence metrics. In some implementations, confidence metrics increase confidence scores based on detected repetitions or iterations of user behavior or behaviors over time, which may be discounted based on lapsed time with respect to one to all of the repetitions or iterations. For example, a confidence score that may have been high in the past may be low in the present based on corresponding user behavior or behaviors having occurred far in the past. In this way, routine tracker 214 can adapt to changing lifestyles in which users may alter their behaviors over time.

Routine tracker 214 can store any of the various data employed in identifying and/or tracking routines of users as routine tracking data 238. In some cases, routine tracking data 238 includes entries that identify routines and assignments between routines and one or more users. The entries may store or otherwise indicate any of the various data associated with a routine, such as behavior parameters of the routine and/or user values of behavior variables of those behavior parameters. In other cases, an entry may simply refer to a routine in association with one or more users without storing or indicating behavior parameters, such as where the routine is completely static. Routine tracking data 238 may also comprise confidence scores that correspond to one or more users with respect to behavior parameters and/or routines.

As indicated above, over time, routine tracker 214 may update routine tracking data 238 as user data is periodically analyzed and confidence scores are determined and/or updated. Furthermore, routine tracking data 238 may optionally be updated based on identifying, altering, and/or suggesting altered routines to one or more users.

FIG. 2 further shows routine modifier 218, which includes alteration component 218a and simulation component 218b. Alteration component 218a is configured to identify alterations of routines and simulation component 218b is configured to simulate the identified alterations of the routines.

Alteration component 218a can identify alterations for a routine of a user, for example, by generating alterations to the routine, and/or matching alterations to the routine (e.g. enumerated alterations). For example, alterations for the first routine may be determined based at least in part on generating and selecting one or more alterations and/or selecting one or more enumerated alterations for the first routine. In some cases, an alteration for a routine may be generated by replacing a routine of a user, for example, with a suitable alternative routine. The suitable alternative routine may include a different set of behavior parameters than the routine. As an example, an alternative to watching TV could be to play a sport. Alternatives to a routine can be determined based on associations between routines in routine management environment 210, which can be stored and potentially updated over time, or can be generated as needed.

In other cases, an alteration for a routine may be generated by replacing, substituting, or changing any of the various parts of the routine, or groups of those parts with one or more other parts (e.g. steps, behaviors and/or actions of the routine). For example, one or more behavior parameters and/or behavior values of the routine with respect to the user could be replaced, substituted, or changed with one or more other behavior parameters and/or behavior values, which were originally not a part of the routine. As an example, one or more of any of the various parts of a routine could be replaced or substituted with one or more other parts. Thus, for example, the routine of eating a pizza could be altered to eating a chicken breast and eating a salad, amongst other possibilities. As another example, the routine of leaving for work at 8:00 AM could be altered to leaving for work at 7:50 AM by varying a behavior parameter within a defined, delineated, or enumerated range.

In some cases, routines and/or behavior parameters may have associated categories. Alterations to a routine may be based on the assigned categories. For example, alteration component 218a may select to replace one or more behavior parameters, or actions, with one or more behavior parameters of based on the replacements belonging to the same category, or otherwise based on the categories of the behavior parameters. Similarly, alteration component 218a may select to replace one or more routines, with another routine based on the replacement belonging to the same category, or otherwise based on the categories of the routines. As an example, playing baseball could be offered as an alternative to watching TV based on both routines belonging to a leisure activity category.

Alteration component 218a may base altering of routines on any number of delineated constraints, such as constraints 224. Constraints can be considered hard constraints or soft constraints. Hard constraints can correspond to constraints that alteration component 218a complies with in altering routines. Soft constraints can correspond to constraints that alteration component 218a favors or prioritizes in altering of routines. Constraints can be defined in many different possible ways and may be delineated for or assigned to any aspect or part of a routine, as well as the routine overall. In some implementations, a constraint can be used to determine a range of alterations, or a group of alterations for a routine. For example, based on a constraint, alteration of a behavior value may favor selection from, or choose from, a range of behavior values. For a hard constraint, the alterations may be limited to the range or group of alterations, and some hard constraints many prevent any alteration of a routine or part(s) of a routine. A constraint for a routine may be defined in terms of a set or group of identified routines for that routine, as one example. A constraint for a part of a routine may be defined in terms of a set, group, or range of substitute parts for that part of the routine.

Some constraints may be user constraints that are associated with one or more users or groups of users, whereas other constraints could be user agnostic constraints. Examples of hard user constraints for a behavior variable that corresponds to a departure time of a behavior parameter is a user has to leave at 6 pm, a user has to leave after 4 pm, or a user can only leave between 4 pm and 6 pm. Any alterations to a routine that correspond to the behavior variable may be generated to comply with corresponding hard user constraints. Thus, in some cases, a constraint may cause alteration component 218a to refrain from altering a part of a routine or the routine as a whole, or could define of or limit the range of possible alterations.

In some implementations, altering of one or more routines of one user may be based on one or more routines of at least one other user. In addition, or instead, altering of one or more routines of one user may be based on one or more alterations made to one or more routines of at least one other user. The users may be part of a group of users, which are identified in the altering of routines of one or more users. For example, a group could correspond to a family, a group of friends, or other associated individuals. Each member of the group may opt into being included in the group. In some cases, at least one user of a group configures membership of the group, for example, on one or more user devices. A user may add, delete, or otherwise modify members of the group as well as any of a variety of group preferences. In some cases, changes to membership, preferences (e.g. performance preferences), or other aspects of the group are changed based on one to all of the members of the group confirming the changes. For example, a notification may be sent to a user device of a user so as to confirm one or more changes to group settings.

In generating and/or selecting alterations of a routine(s) with respect to multiple users, alteration component 218a can consider hard and soft constraints of one to all users impacted by any alterations. Furthermore, at least some hard or soft constraints can relate to multiple users and/or a group of users. As an example, a hard constraint between users could be that a user that is a father has to take a user that is his daughter to school. A hard constraint at the group level could be that someone in the group (i.e. a user other than the daughter) needs to pick the daughter up from school.

Alterations between multiple users, which may be within a group of users, can be based on avoiding, minimizing, or reducing violations of hard and/or soft constraints of one or more users and/or a group that includes the users. In avoiding conflicts, alteration component 218a may be configured to avoid selection and/or identification of alterations to one user's routine(s) that would violate or cause one or more other users to violate one or more hard constraints of one or more users and/or the group of the users. The same may optionally be performed with respect to soft constraints.

It is not always possible to completely comply with all hard and soft constraints. For example, conflict between some hard and/or soft constraints may be unavoidable in the altering of routines. Alteration component 218a may be configured to prioritize compliance with hard constraints over compliance with soft constraints. As one example, alteration component 218a may optionally be configured to comply with a hard constraint, where a conflict exists between a hard and one or more softs constraint. For example, alteration component 218a may identify a conflict and comply with the hard constraint based on the conflict. In doing so, if the hard constraint corresponds to a range or group of values, alterations to a routine(s) may be selected as the closest value that complies with the hard constraint to value or values of the soft constraint.

Where conflicts exist between hard constraints, alterations in to routines may still be made where a conflict level that corresponds to the number of conflicts is not exceeded, or regardless of a conflict level. In some cases, alteration component 218a is configured to reduce conflicts between hard constraints of users and/or a group of the users in existing routines of the users (when conflicts exist) in selecting and/or generating altered routines for the users. Also, alteration component 218a can be configured to minimize or otherwise consider the number of conflicts in selecting and/or generating altered routines for users. For example, alteration component 218a may select a set or sets of alterations based on the number of constraint conflicts in the set of sets. As an example, the set having the lowest number of constraint conflicts could be selected, or the sets having the five (or another designated number) lowest number of constraint conflicts could be selected.

Alterations between multiple users, which may be within a group of users, can also be based on avoiding conflicts between routines of one or more users. For example, alterations to a routine(s) of one user that would conflict with a routine(s) of another user may be avoided, or the routine(s) of both users may be collectively altered, such that the altered routines are free from conflict. As an example, one user may be a wife that includes a routine to drive home from work at 6 pm. Another user may be a husband that has a routine to pick up dinner for the husband and wife at 6:10 pm. An alteration to the wife's routine may be to pick up dinner in the routine on the way home from work. In order to avoid conflict between routines of the users, the husband's routine(s) may be altered to exclude picking up dinner.

In some cases, alterations to routines based on multiple users may combine at least some parts of routines with routines of different users. For example, step(s) or action(s) of a routine of one user may be combined with corresponding step(s) or action(s) in one or more other routines of one or more other users. Routines that overlap or may overlap with some amount of alteration may be combined between users. As an example, alterations to routines of users that go to the same work site separately as part of their routines could be based on combining the routines such that each user's routines include going to work with the other user. In doing so, constraints of each user and/or the routines of each user may be considered. For example, if one user had a hard constraint of going to the work site at 7 am and another had a hard constraint of going to work site between 8 am and 9 am, the alterations to combine the routines may not be selected by alteration component 218a despite the overlap in routines. However, if aforementioned the constraints for one or more of the users were a soft constraint; the alterations may still be considered. Thus, a soft constraint on a part of a routine for one user may be altered to comply with a corresponding hard constraint of another user in combining routines.

In addition to, or instead of combining routines between users, alterations may comprise offloading one or more routines and/or one or more parts of routines of one user to another user, such as another user in the same group of users. For example, one or more actions or steps in a routine(s) of one or more users may be incorporated into a routine of one or more other users and removed from the routine(s) of the one or more other users.

In some respects, at least some of the alterations to routines may be generated and/or selected by alteration component 218a in conjunction with simulation component 218b. Simulation component 218b is configured to simulate routines with one or more alterations based on historical data associated with the one or more alterations. In this capacity, simulation component 218b may employ data collection component 216 for access to the historical data. The simulations can predict a performance score with respect to multiple future iterations of the altered routine(s), such that the performance scores can quantify the relative performance of the altered routine(s) overall in aggregate for an extended term.

A predicted performance score can be compared to a performance score generated based on one or more unaltered routines as performed by one or more users. The predicated performance score may be compared to the performance score so as to determine whether or not an alteration for a routine(s) would improve, degrade, or maintain performance with respect to the unaltered routines(s) for the one or more users the alteration would impact. In this regard, each performance score employed may be generated from a common performance metric. Thus, performance scores can be compared and relative performance may be evaluated.

A performance score corresponding to an unaltered routine(s) utilized in the comparison may be with respect to the routine as performed by the one or more users. Thus, the performance score may be generated from user data, which may be updated over time as the user(s) performs multiple iterations of the routine. For example, a performance metric utilized to generate the performance score may derive any number of variables for the performance metric from user data that corresponds to actual routines performed by one or more users that the altered routine would impact. Thus, user data for any to all variables may span at least a number of days, weeks, months, years, or more.

For performance scores of altered routines, simulation component 218b can employ historical data to derive any number of variables of a performance metric for altered routines. Historical data for any to all variables may span at least a number of days, weeks, months, years, or more. Historical data may be fed into performance metrics so as to be predictive of performance of alterations of routines over multiple future iterations. Thus, compared to the unaltered routine at least some of the historical data may additionally or instead correspond to user data of users other than the one or more users the altered routine would impact.

Historical data and/or user data that is fed into performance metrics may correspond to data that relates to completed world or user events, such as actions, steps, or routines of one or more users. In some cases, data fed into performance metrics may exclude or otherwise refrain from considering data that corresponds to current conditions that may impact performance scores generated by the performance metric. Furthermore, a performance metric may exclude or discount recently collected data, such as the most recent 24 hours (or another designated time quantity) of data (which may be determined by a time stamp and/or by the time of collection). Also, in some cases, the most recent data could be included, but is not given additional weight or significance due to its recency in determining performance scores. For example, recent historical data may be weighted identically to older historical data as applied to a performance metric in determining a performance score. As a more particular example, a performance metric may include an average of all historical data corresponding to one or more variables in the performance metric, or the data may otherwise be equally weighted in determining those variables in terms of the recency of the data. As another example, the one or more variables could correspond to a mean or mode of historical data.

In order to characterize an altered routine with respect to its corresponding unaltered routine, or other possible altered routines, performance scores for each variation may be determined using a common performance metric. In this way, a performance score may reflect whether or not one routine is better (e.g. an improvement to), worse (e.g. a degradation to), or the same as another routine.

Some performance metrics that are generated could be group performance metrics, and other performance metrics could be user performance metrics. Group performance metrics may characterize performance of a set of routines with respect to a group of users. A group performance metric may correspond to a combination of a user performance metrics. Thus, a group performance metric may be defined in terms of user performance metrics. For example, a group performance metric could combine performance scores that correspond to user performance metrics to characterize performance of the overall group. As an example, a group performance metric may correspond to an average of performance scores of user performance metrics. In some cases, user performance metrics may have different assigned weights in a group performance metric. In this way, certain users of a group may have more weight, or importance, in characterizing the overall performance of a set of altered routines for the group.

By employing one or more group performance metrics, performance of a set of altered routines for a group of users may be characterized as an improvement over a set of unaltered routines, even where an altered version of a routine of a user in the set of altered routines is degradation to performance of the routine for the user, with respect to a user performance metric. Thus, a group performance metric may be utilized to improve the group overall.

In some cases, multiple performance metrics and multiple performances scores may be available for characterizing a routine. For example, each performance metric could correspond to a different performance preference. A performance preference can correspond to a unique characterization of a routine. One performance preference could favor routines that save time. Another performance preference could favor routines that save money. Another performance preference could favor routines that balance savings of time and money. Yet another performance preference may favor routines that promote fitness.

In some implementations, user accounts 222 includes performance preferences 226, which can include assignments between users and/or groups and performance preferences. Performance metrics utilized to characterize a routine or group of routines may be selected based on performance preferences 226. For example, a user performance metric may be selected that favors saving money based on that users performance preferences. In this way, characterizations of routines may be customized to users. In some cases, performance scores from different user and/or group performance metrics may be normalized, such that those scores can be compared to one another. Thus, for example, a group performance metric may more effectively consider different performance preferences of different users is characterizing routines with respect to a group.

In some cases, alteration component 218a may store data corresponding to altered routines in routine tracking data 238 based on the performance scores. For example, alteration component 218a may optionally utilize the performance scores to determine which generated altered routines are stored in routine tracking data 238. For example, altered routines may be stored based on having a performance score exceeding a threshold value. Furthermore, alteration component 218a may optionally utilize the performance scores to prune altered routines. For example, performance scores may periodically be recalculated for one or more altered routines over time as additional historical data becomes available to simulation component 218b. As such, alteration component 218a may prune, or delete, data corresponding to an altered routine from routine tracking data 238 based on a performance score falling below a threshold value (which may be the same or different than the aforementioned threshold value).

Thus, routine modifier 218 can generate, evaluate, and track altered routines of one or more users and/or groups of users. Routine modifier 218 may thereby be utilized to discover new routines or modifications to existing routines for one or more users and/or groups of users. While a person may be aware of certain behavior or routines, people have varying levels of skill, knowledge, and/or time that limits their ability to effectively assess and alter their routines. Furthermore, the options for altering their routines are essentially infinite. By implementing routine management environment 210, this infinite pool of options can be distilled to options that are likely to have a significant long term impact on the person's quality of life.

Presentation component 220 is configured to control interactions between users and routine management environment 210, which includes when and/or how the aforementioned options are presented to one or more users, for example, on any combination of user devices 102a and 102b through 102n. In this capacity, presentation component 220 may employ any of the various data shown with respect to user accounts 222 in routine tracking data 238, as well as other data.

In some cases, presentation component 220 may present one or more alterations of routines to a user using code of an application on a user device. In addition, or instead, presentation component 220 may present one or more alterations of routines to a user using code of an operating system on the user device. In either scenario, presentation component 220 may operate within the user device, or at least some functionality may be incorporated into a server, such as server 106. Furthermore, presentation may be accomplished by way of any combination of displays, speakers, or other available components on the user device.

In some cases, presentation component 220 may present one or more alterations of routines based associated performance scores. For example, an alteration may be presented based on an associated user performance score exceeding a threshold value. In some cases, the threshold value could correspond to a performance score of a corresponding unaltered routine with respect to one or more users that the alteration would impact. Thus, for example, only alterations that improve the routine may be presented to the user, or improve the routine by a threshold amount, as quantified by one or more performance metrics. Furthermore, presentation component 220 may determine which alterations of routines to present based on relative performance scores associated with each routine as altered. In some cases, the top four, or other number alterations for routines in terms of performance score may be selected for presentation. Any of the selected alterations may be selected concurrently, or at different times.

At least some of the alterations to routines that are presented to users may have been generated, identified, and or selected for presentation at least hours, days, weeks, months, or even one or more years in advance to when the alterations are actually presented to the user. For example, some alterations may not have previously been selected for presentation to the user when considered amongst other possible alterations to routines to present based on any of a variety of possible selection criteria related to presentation. In other cases, any of a variety of presentation criteria may not have been satisfied, such as those based on user context, performance scores, and/or performance preferences.

Presentation may optionally be based on performance preferences of the user, such as those included in performance preferences 226. For example, presentation component 220 may only consider performance scores from performance metrics that correspond to one or more designated performance preferences. Thus, for example, the top time saving alterations of a routine or routines may be presented to the user, amongst other possibilities.

In some cases, an alteration of a routine may be presented based on user context, which may be linked to a user action on a user device. For example, an alteration for a routine may be presented to a user that has a high performance score in a performance preference related to fitness, when the user opens an application related to in the same performance preference on a user device, such as a fitness app. In other cases, routines may be categorized, for example, by domain, and alterations may be presented to the user based on user actions associated with the category, or domain. For example, when a user opens an app in the category of finance, an alteration for a routine categorized as finance may be displayed.

In some case, presentation component 220 is configured to receive user feedback from one or more users based on presenting one or more alterations of routines to the one or more users. For example, user feedback may comprise a grade that indicates a level of satisfaction one or more users has with the presented alteration of the routine. Grades could correspond to negative or positive evaluations, or a range therebetween. Grades can optionally be fed back into routine modifier 218 and can be factored into further alterations of routines, selection of routines for presentation, and/or other data utilized to track routines of users.

In some implementations, in response to a negative or relative negative evaluation of an alteration of a routine, a user may be presented with a plurality of options. Each option may correspond to one or more performance preferences, and/or one or more potential hard or soft constraints, and selection of the option may alter corresponding associations between the user and that data in user accounts 222. For example, a user may select an option indicating that a suggested flight one an airline is too expensive, which strengthens a performance preference for reducing costs for that user. As another example, an alteration to a routine may suggest that the user leave for a flight this year on Thursday instead of the usual Friday and the user selects an option indicating that the user has to leave on Friday. In response, constraints 224 may indicate that the behavior value of Friday is a hard constraint for the user for a corresponding routine and/or behavior parameter. In contrast, selection of an option corresponding to I want to leave on Friday may have resulting in constraints 224 indicating that the behavior value of Friday is a soft constraint.

As another example, irrespective of user evaluations, multiple alterations of a routine could be presented to the user, and each may be associated with a different performance parameter(s) with respect to one another. Selection of one of the multiple alterations could update or strengthen associations to corresponding performance preferences in performance preferences 226.

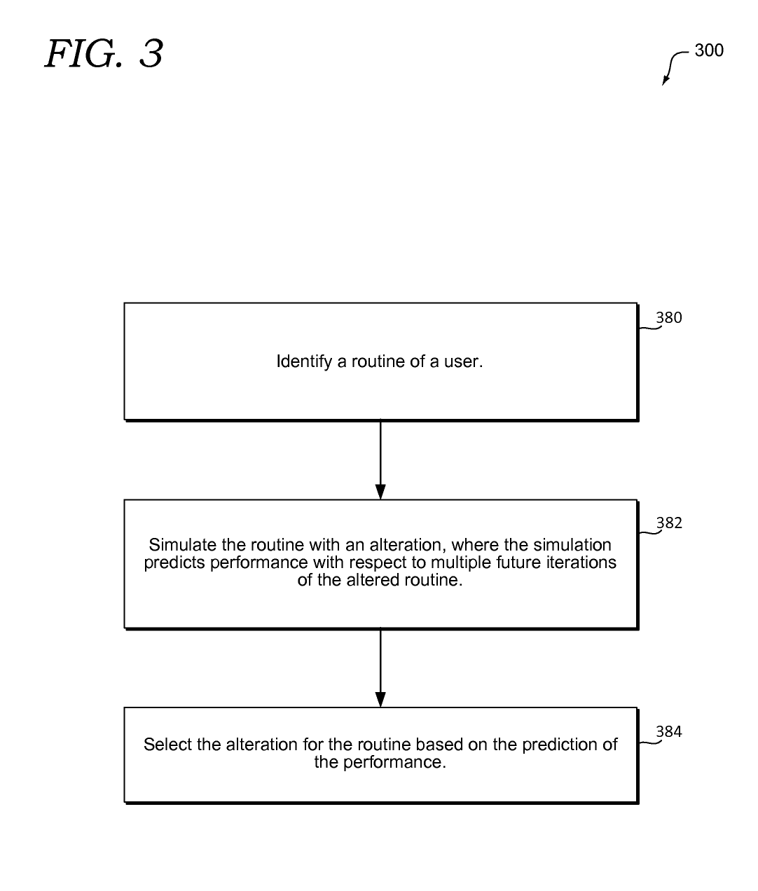

Thus, implementations of the present disclosure relate to the identification and altering of user routines. Referring now to FIG. 3 with FIGS. 1 and 2, FIG. 3 is a flow diagram showing method 300 for analyzing routines of users. Each block of method 300 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few.

At block 380, method 300 includes identifying a routine of a user. The routine can correspond to at least one recurring behavior of the user. In some cases, the routine may be identified from routine tracking data 238 based on an association between the routine and the user. For example, the routine may be identified based one or more or confidence scores indicating that the user performs the routine.

At block 382, method 300 includes simulating the routine with an alteration, where the simulation predicts performance with respect to multiple future iterations of the altered routine. For example, the simulation may be based on historical data associated with the alteration, and the prediction may correspond to a performance score that is generated from a performance metric. The historical data may optionally include user data that corresponds to one or more users in addition to or instead of the user. For example, the simulation may be based on user data corresponding to routines of one or more other users that include at least a portion of the altered routine, or a similar routine as the altered routine. The user data could optionally comprise corresponding performance scores of those users. In addition, or instead, the simulation may be based on at least some historical data that corresponds to the altered routine, but not to the unaltered routine. For example, where the alteration changes a departure time of a user's trip, the historical data may correspond to traffic conditions at the new departure time over at least a number of days, weeks, or years.

At block 384, method 300 includes selecting the alteration for the routine based on the prediction of the performance. For example, the selecting of the alteration for the routine could be based on the predicted first performance score and a second performance score that is determined with respect to the unaltered routine, such as the unaltered routine as performed by the user. The first performance score may be compared to the second performance score so as to evaluate the alteration for the routine with respect to the unaltered routine for the user. Thus, for example, the selecting may be based on the comparison indicating an improvement to the unaltered routine where the first performance score exceeds the second performance score.

The selecting could be for presentation to the user, for example, on user device 102a. Thus, the altered routine may be presented to the user based on the selecting. The alteration of the routine may optionally be presented to the user with other alterations of the routine. Furthermore, user feedback may be generated by the user based on the presenting. The user feedback can be used by routine management environment 210 to adjust how alterations for routines are generated, which alterations for routines are generated, and/or which alterations are simulated or selected.

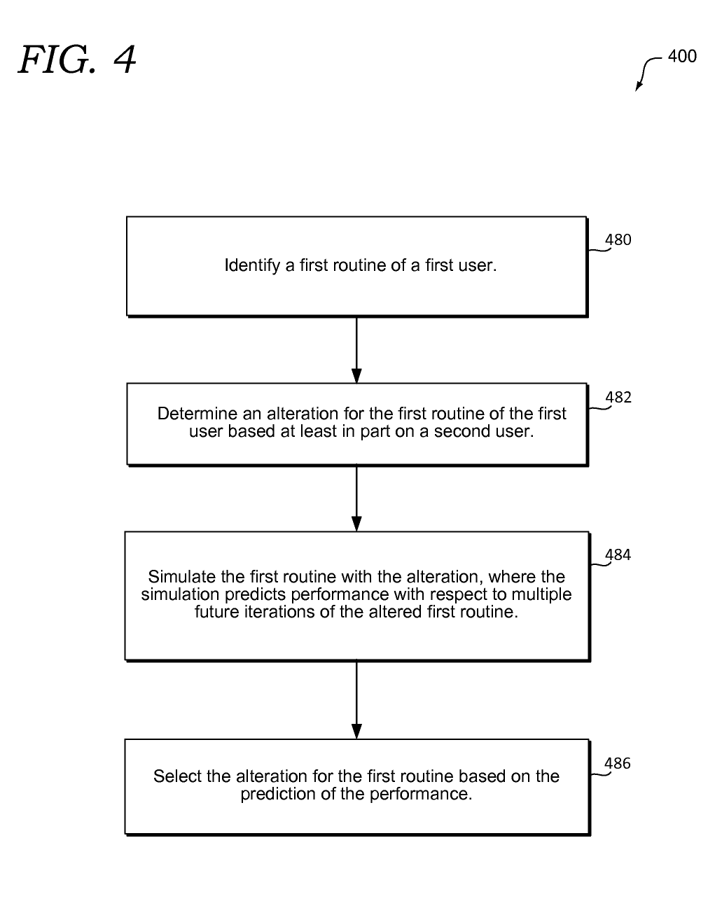

Referring now to FIG. 4 with FIGS. 1 and 2, FIG. 4 is a flow diagram showing method 400 for analyzing routines of users. At block 480, method 400 includes identifying a first routine of a first user. The first routine can correspond to at least one recurring behaviors of the first user. The first routine may be identified from routine tracking data 238 based on an association between the first routine and the first user in routine tracking data 238.

At block 482, method 400 includes determining an alteration for the first routine for the first user based at least in part on a second user. For example, the alteration for the first routine of the first user may be determined, and in some cases, generated, based at least in part on a second routine of a second user, where the second routine corresponds to at least one recurring behavior of the second user. The second routine may only correspond to the second user, may not correspond to the first user, and/or may correspond to multiple users. As an example, in determining the alteration, alteration component 218a may consider hard and/or soft constraints of the second routine and/or of the second user. Furthermore, the alteration may be determined by combining at least a portion of the first routine with at least a portion of the second routine, and/or offloading at least a portion of the second routine to the first routine, as some examples. The determining may also consider any of various group based factors where the first and second users are both members of a group.

At block 484, method 400 includes simulating the first routine with the alteration, where the simulation predicts performance with respect to multiple future iterations of the altered first routine. For example, the prediction may correspond to a performance score, such as a group performance score that captures a set of altered routines for a group of users that includes the altered routine, or a user performance score that captures the altered routine(s) for the user.

At block 486, method 400 includes selecting the alteration for the first routine based on the prediction of the performance. For example, the alteration may be selected for the first routine based on the above mentioned performance score. In some cases, the selection of the alteration for the first routine could be based on the predicted first performance score and a second performance score with respect to at least the unaltered first routine. The selection could be for presentation to the first user. Where the altered first routine is selected as part of a group of altered routines, any alterations to routines may be only presented to corresponding users that are intended to perform the alterations, for example, on respective user devices 102a and 102b through 102n.

Having described implementations of the present disclosure, an exemplary operating environment in which embodiments of the present invention may be implemented is described below in order to provide a general context for various aspects of the present disclosure. Referring initially to FIG. 5 in particular, an exemplary operating environment for implementing embodiments of the present invention is shown and designated generally as computing device 500. Computing device 500 is but one example of a suitable computing environment and is not intended to suggest any limitation as to the scope of use or functionality of the invention. Neither should the computing device 500 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 5, computing device 500 includes bus 510 that directly or indirectly couples the following devices: memory 512, one or more processors 514, one or more presentation components 516, input/output (I/O) ports 518, input/output components 520, and illustrative power supply 522. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 5 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 5 and reference to “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 500. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer-storage media in the form of volatile and/or nonvolatile memory. The memory may be removable, non-removable, or a combination thereof. Exemplary hardware devices include solid-state memory, hard drives, optical-disc drives, etc. Computing device 500 includes one or more processors that read data from various entities such as memory 512 or I/O components 520. Presentation component(s) 516 present data indications to a user or other device. Exemplary presentation components include a display device, speaker, printing component, vibrating component, etc.

I/O ports 518 allow computing device 500 to be logically coupled to other devices including I/O components 520, some of which may be built in. Illustrative components include a microphone, joystick, game pad, satellite dish, scanner, printer, wireless device, etc. The I/O components 520 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as, stereoscopic camera systems, infrared camera systems, RGB camera systems, and combinations of these for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

As can be understood, implementations of the present disclosure provide for identification and altering of user routines. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform operations comprising:
identifying a first routine of a first user, wherein the first routine corresponds to at least one recurring behavior of the first user;
determining an alteration for the first routine of the first user based at least in part on a second routine of a second user, wherein the second routine corresponds to at least one recurring behavior of the second user;
simulating the first routine with the alteration based on historical data associated with the alteration, wherein the simulation predicts a first performance score with respect to multiple future iterations of at least the altered first routine;
selecting the alteration for the first routine based on the predicted first performance score and a second performance score with respect to at least the unaltered first routine; and
presenting the selected alteration for the first routine to the first user.

2. The one or more computer storage media of claim 1, wherein the alteration for the first routine offloads at least a portion of the second routine to the first routine.

3. The one or more computer storage media of claim 1, wherein the alteration for the first routine combines at least a portion of the second routine with the first routine.

4. The one or more computer storage media of claim 1, wherein the identifying the alteration for the first routine is based on at least one hard constraint of the second user.

5. The one or more computer storage media of claim 1, wherein the selecting the alteration for the first routine is further based on a first group performance score that incorporates the predicted first performance score and a second group performance score that incorporates the second performance score.

6. The one or more computer storage media of claim 5, wherein the predicted first performance score corresponds to a degradation of the second performance score and the selecting is based on the first group performance score indicating an improvement to the second group performance score.

7. The one or more computer storage media of claim 1, further comprising receiving user feedback from the first user, wherein the user feedback indicates a level of satisfaction of the first user with respect to the presented alteration for the first routine.

8. The one or more computer storage media of claim 1, further comprising a modifying a performance preference of the first user based on user feedback received in response to the presenting of the selected alteration.

9. The one or more computer storage media of claim 1, wherein the alteration for the first routine violates a user constraint of at least one of the first and second users.

10. The one or more computer storage media of claim 1, further comprising generating the alteration for the first routine at least one day prior to the presenting.

11. A computer implemented method comprising:
identifying a routine of a user, wherein the routine corresponds to at least one recurring behavior of the user;
simulating the routine with an alteration based on historical data associated with the alteration, wherein the simulating predicts a first performance score with respect to multiple future iterations of the altered routine;
selecting the alteration for the routine based on the predicted first performance score and a second performance score with respect to the unaltered routine; and
presenting the selected alteration for the routine to the user.

12. The computer implemented method of claim 11, wherein the predicted first performance score and the second predicted performance score are generated using a common performance metric.

13. The computer implemented method of claim 11, wherein the selecting is based on the predicted first performance score indicating an improvement with respect to the second performance score.

14. The computer implemented method of claim 11, wherein the second performance score corresponds to the unaltered routine as performed by the user.

15. The computer implemented method of claim 11, wherein the simulating is performed at least one day prior to the presenting of the selected alteration for the routine to the user.

16. The computer implemented method of claim 11, wherein the selecting of the alteration is based on at least one performance preference of the user.

17. The computer implemented method of claim 11, further comprising generating the alteration for the routine based on at least one hard constraint of the user.

18. A computerized system comprising:
one or more processors; and
one or more computer storage media storing computer-useable instructions that, when used by the one or more processors, cause the one or more processors to:
identify a routine of a user, wherein the routine corresponds to at least one recurring behavior of the user;
simulate the routine with an alteration based on historical data associated with the alteration, wherein the simulation predicts a first performance score with respect to multiple future iterations of the altered routine;
select the alteration for the routine based on the predicted first performance score and a second performance score with respect to the unaltered routine; and
present the selected alteration for the routine to the user.

19. The computerized system of claim 18, wherein the alteration for the routine is selected based on the predicted first performance score indicating an improvement with respect to the second performance score.

20. The computerized system of claim 18, wherein the second performance score corresponds to the unaltered routine as performed by the user.
